(19) United States
(12) Patent Application Publication
(10) Pub. No.: US 2016/0238386 A1
(43) Pub. Date: Aug. 18, 2016

(54) DISTANCE MEASURING METHOD, DISTANCE MEASURING SYSTEM AND PROCESSING SOFTWARE THEREOF

(71) Applicant: PixArt Imaging Inc., Hsinchu (TW)

(72) Inventors: Shu-Sian Yang, HSINCHU (TW); Hsin-Chia Chen, HSINCHU (TW); Ren-Hau Gu, HSINCHU (TW); Sen-Huang Huang, HSINCHU (TW)

(21) Appl. No.: 15/136,991

(22) Filed: Apr. 25, 2016

Related U.S. Application Data
(63) Continuation of application No. 13/294,151, filed on Nov. 10, 2011.

(30) Foreign Application Priority Data
Nov. 10, 2010 (TW) 099138679

(51) Int. Cl. G01C 3/08; H04N 5/225; H04N 5/33; H04N 7/18

(52) U.S. Cl. CPC G01C 3/08; H04N 7/183; H04N 5/2256; H04N 5/33

(57) ABSTRACT

A distance measuring system includes a light source module, an image capturing device and a processing module. The light source module transmits a light beam having a speckle pattern to a first flat surface and a second flat surface, and an object. The image capturing device captures the image of the speckle pattern shown on the first and second flat surfaces, and captures the image of the speckle pattern shown on a surface of the object to produce first reference image information, second reference image information, and object image information. The processing module calculates a displacement vector of the speckle pattern according to the first and second reference image information. The processing module calculates the relative distance between the object and the first flat surface or the second flat surface according to the position of the speckle pattern on the object image information and the displacement vector.

### FIELD OF THE INVENTION

The present invention relates to a distance measuring technique, and more particularly, relates to a three dimensional distance measuring technique.

### BACKGROUND OF THE INVENTION

Current distance measuring instruments can be divided into contacting type and non-contacting type, wherein so-called contacting type distance measuring instruments, which is traditional distance measuring technique, for example, include coordinate measuring machines (CMM). Although contacting type distance measuring technique is very accurate, however, it is necessary to contact the body of an object, which may cause the object is damaged by a probe of the distance measuring instruments. Thus, contacting type distance measuring instruments are not suitable for measuring expensive objects.

Compared with traditional contacting type distance measuring instruments, because the operation frequency of non-contacting type distance measuring instruments is up to several millions, thus they have been used in various fields. Non-contacting type distance measuring technique is further divided into active type and passive type. So-called active non-contacting distance measuring technique includes projecting an energy wave to an object and then calculating the distance between the object and a reference point through the reflection of the energy wave. Typical energy waves include general visual light, high energy light beams, ultrasonic wave and X-ray.

### SUMMARY OF THE INVENTION

The present invention provides a distance measuring system and a distance measuring method, which detects the position of an object with a non-contacting manner.

The present invention also provides a storage media, having processing software stored therein, which can be installed in the distance measuring system for parsing the position of the object.

A distance measuring system provided by the present invention comprises a light source module, an image capturing device, and a processing module. The light source module projects a light beam having a speckle pattern to a first flat surface and a second flat surface, so as to show the speckle pattern on the first flat surface and the second flat surface. The speckle pattern has a plurality of speckles. In addition, the image capturing device captures the image of the speckle pattern shown on the first flat surface and the second flat surface to produce first reference image information and second reference image information. Furthermore, the image capturing device captures an image of the speckle pattern on an object when the light beam is transmitted to the object, so as to produce object image information. The processing module is coupled to the image capturing device to obtain the first reference image information and the second reference image information for calculating a displacement vector of the speckle pattern shown on the first reference image information and the second reference image information. Therefore, the processing module could compare the object image information with one of the first reference image information and the second reference image information to obtain displacement information of the speckle pattern shown on the object image information, so as to calculate the relative distance between the object and the first flat surface or the second flat surface according to the displacement vector.

In an embodiment of the present invention, the light source module includes a laser light source and a light diffusing element. The laser light source is capable of emitting a laser beam to the light diffusing element such that interference and diffraction of the laser beam occur in the light diffusing element to form the light beam. The light diffusing element is a diffusion sheet, a piece of ground glass or an optical diffraction element.

According to another aspect, a distance measuring method provided by the present invention comprises transmitting a light beam having a speckle pattern, which has a plurality of speckles, to a first flat surface and a second flat surface. Then the images of the speckle pattern shown on the first flat surface and the second flat surface are captured to obtain first reference image information and second reference image information. Therefore, the present invention can calculate a displacement vector of the speckle pattern. The displacement vector of the speckle pattern is the position variation of the speckle pattern shown on the first flat surface and the second flat surface. On the other hand, the method also comprises projecting the light beam to an object and capturing the image of the speckle pattern shown on the surface of the object that is towards the light beam to obtain object image information. Meanwhile, the present invention can calculate the relative distance between the object and the first flat surface or the second flat surface according to displacement information of the speckle pattern shown on the object image information and the displacement vector.

In an embodiment of the present invention, the step of calculating the relative distance between the object and the first flat surface or the second flat surface includes comparing the object image information with one of the first reference image information and the second reference image information to obtain the displacement information of the speckle pattern on the object image information. In succession, relative distance between the object and the first flat surface or the second flat surface is calculated according to the obtained displacement information of the speckle pattern and the displacement vector.

In another embodiment, the present invention can also establish at least one of an adjusting formula and an adjusting value lookup table. As such, the present invention can calculate the absolute position of the object according to the displacement information in the object image information of each speckle, the corresponding displacement vector, and the at least one of the adjusting formula and the adjusting value lookup table.

According to another aspect, a storage media provided by the present invention has a processing software, which is suitable for installing in a distance measuring system for analyzing the position of an object. When the processing software is installed in the distance measuring system, the steps performed by the processing software comprise receiving first reference image information and second reference image information, which are images of a speckle pattern shown on a first flat surface and a second flat surface by reflecting the speckle pattern projected by the light beam, wherein the speckle pattern has a plurality of speckles. After that, the position variation of the speckle pattern shown on the first reference image information and the second reference image information is calculated to obtain the displacement vectors of the speckle pattern. In addition, the present invention also receives object image information, which is the image of the speckle pattern shown on an object by reflecting the light beam. Then, the present invention compares the object image information with the first reference image information or the second reference image information to obtain the displacement information on the object image information of the speckle pattern, and calculates the relative distance between the object and the first flat surface or the second flat surface according to the displacement information on the object image information and the displacement vector.

The present invention projects a speckle pattern onto the first flat surface and the second surface to obtain the displacement vector of each speckle in the speckle pattern. As such, the present invention can compare the image of the speckle pattern shown on a surface of the object with the image on the first flat surface or the second flat surface to calculate the position of the object.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view illustrating a distance measuring system in accordance with the first embodiment of the present invention;

FIG. 2 is a schematic view illustrating a light beam having a speckle pattern in accordance with a preferred embodiment of the present invention;

FIG. 3 and FIG. 4 are schematic views illustrating the images of the speckle pattern shown on different flat surfaces in accordance with an embodiment of the present invention;

FIG. 5 is a schematic view illustrating the position variation of each speckle in different flat surfaces in accordance with a preferred embodiment of the present invention;

FIG. 6 is a schematic view illustrating an image of the speckle pattern shown on a surface of the object in accordance with a preferred embodiment of the present invention;

FIG. 7 is a schematic view illustrating a distance measuring system in accordance with the second embodiment of the present invention;

FIG. 8 is a schematic view illustrating a distance measuring system in accordance with the third embodiment of the present invention.

FIG. 9 is a flow chart illustrating the steps of a distance measuring method in accordance with a preferred embodiment; and

FIG. 10 is a flow chart illustrating the steps of calculating the position of the object according the displacement vector of each speckle in accordance with another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

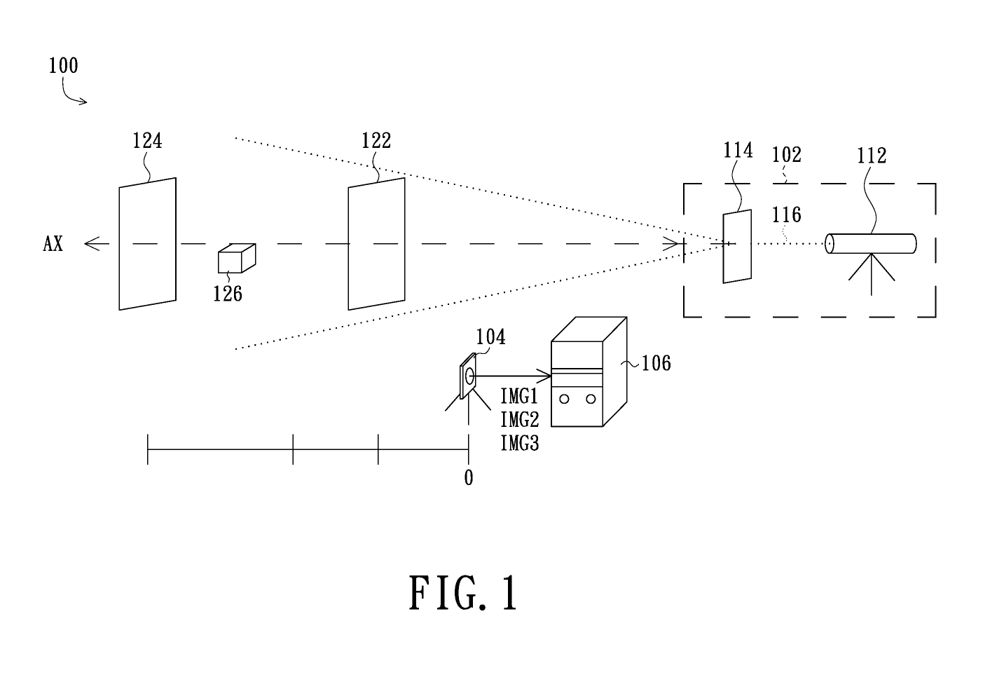

FIG. 1 is a schematic view illustrating a distance measuring system in accordance with the first embodiment of the present invention. Referring to FIG. 1, the distance measuring system 100 provided by the present embodiment includes a light source module 102, an image capturing device 104, and a processing module 106. The light source module 102 can transmit a light beam, and project a speckle pattern to a detecting range. In addition, the image capturing device 104 can couple the processing module 106.

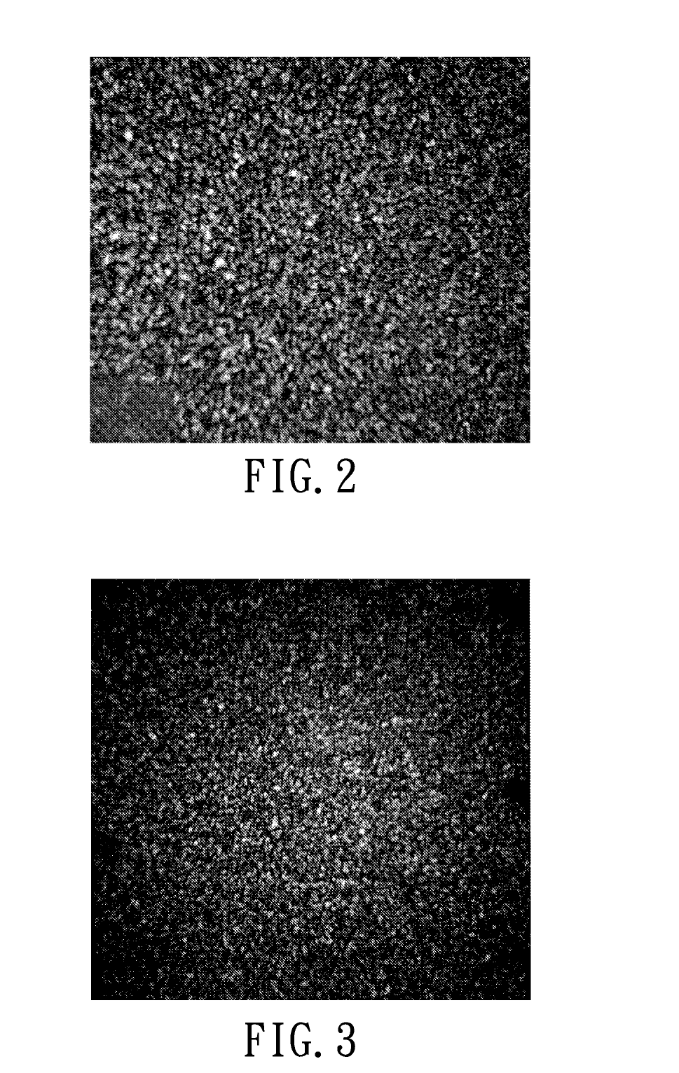

In the present embodiment, the light source module 102 includes a laser light source 112 and a light diffusing element 114. The laser light source 112 can be a gas laser, for example, He—Ne laser, or a semiconductor laser. In addition, the light diffusing element 114 can be a diffusion sheet, a piece of ground glass or an optical diffraction element. When a laser beam 116 transmitted from the laser light source 112 is irradiated onto the light diffusing element 114, diffraction occurs in the light diffusing element 114 thereby forming a source light source, as shown in FIG. 2. It can be clearly viewed in FIG. 2 that this light beam projects a speckle pattern, and the speckle pattern has a number of speckles.

Referring back to FIG. 1, in the present embodiment, the light source module 102 can separately project the speckle pattern onto a first flat surface 122 and a second flat surface 124. In some embodiments, the first flat surface 122 and the second flat surface 124 are parallel with each other in a visual range, and in some alternative embodiments, the first flat surface 122 and the second flat surface 124 can be achieved by disposing a same flat surface on different positions. Additionally, the first flat surface 122 and the second flat surface 124 can be substantially perpendicular to the optical axis AX of the laser beam 116.

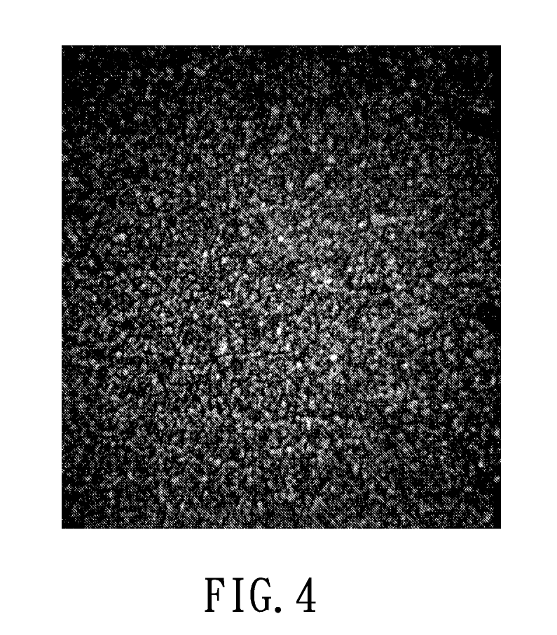

When the speckle pattern is projected to the first flat surface 122 and the second flat surface 124, the image of the speckle pattern will be produced on the first flat surface 122 and the second flat surface 124, as shown in FIG. 3 and FIG. 4, respectively. At this moment, the image capturing device 104 captures the image of the speckle pattern shown on the first flat surface 122 and the second flat surface 124 and produces first reference image information IMG1 and second reference image information IMG2 for the processing module 106. The processing module 106 can be a computer system or processing software, which can be used to parse the position of an object, and the detail principle will be described in the following paragraphs.

In addition, the image capturing device 104 can be a camera or a charge coupled device (CCD). When the image capturing device 104 produces the first reference image information IMG1 and the second reference image information IMG2 and sends them to the processing module 106, the processing module 106 compares the both to obtain the position variation of the speckle pattern on the first flat surface 122 and the second flat surface 124, so as to obtain the displacement vector of the speckle pattern.

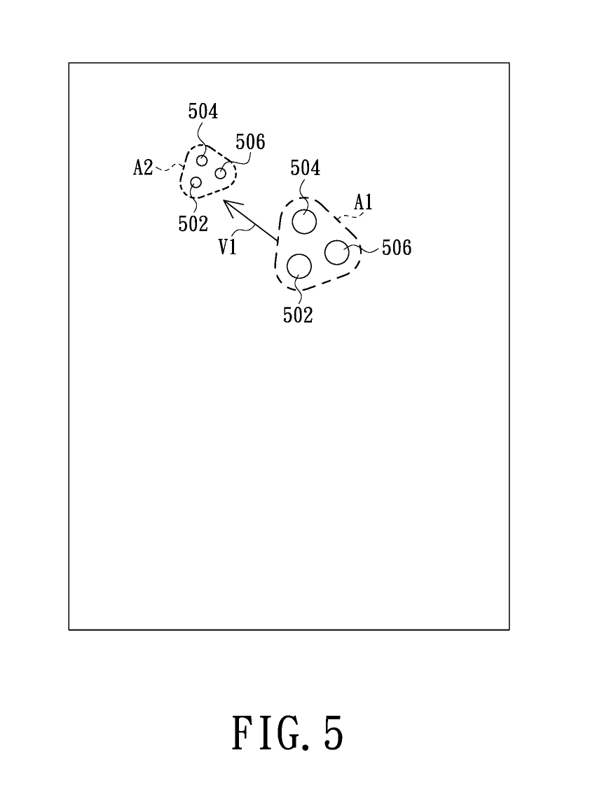

FIG. 5 is a schematic view illustrating the position variation of each speckle in different flat surfaces in accordance with a preferred embodiment of the present invention. In the present embodiment, when the speckle pattern is projected on the first flat surface 122, the location of the speckle 502, 504, and 506 is in the region A1, and when the speckle pattern is projected on the second flat surface 124, the location of the speckle 502, 504, and 506 will be moved to the region A2. Since the first flat surface 122 is closer to the light source module 102 compared with the second flat surface, thus the size of the speckle shown on the first flat surface is bigger. It can be known from FIG. 5 that when the speckle pattern is projected on different flat surfaces, the speckle pattern has a displacement. Therefore, the processing module 106 can calculate the displacement vector, for example, the displacement vector V1, according to the position variation of the speckle pattern in different flat surfaces.

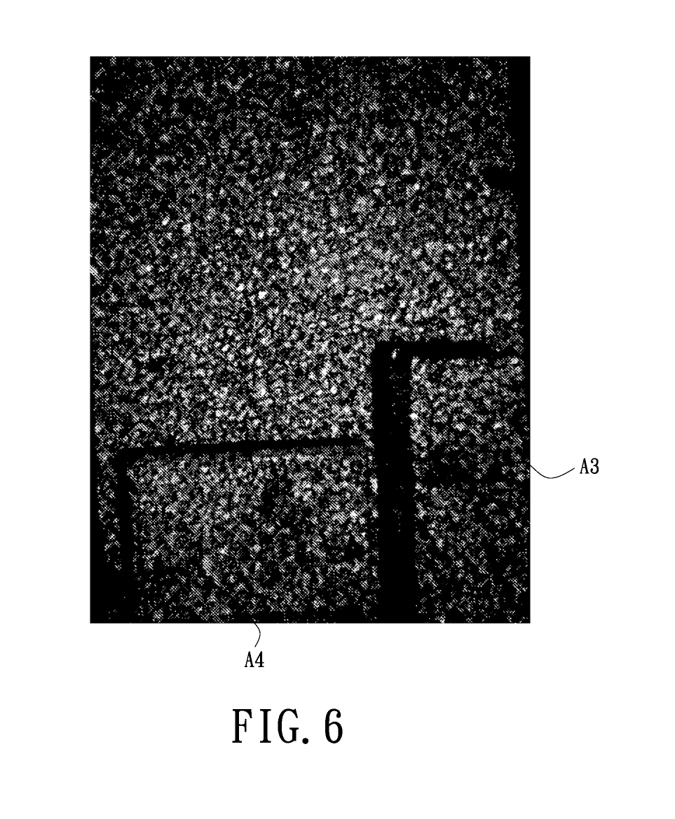

Referring continuously to FIG. 1, when an object 126 moves to a detection range, the surface of the object that is towards the surface light reflects the light beam thereby showing an image of the speckle pattern. FIG. 6 illustrates a schematic view of an image of the speckle pattern shown on a surface of the object in accordance with a preferred embodiment of the present invention. In FIG. 6, the images in regions A3 and A4 are the image of the speckle pattern shown on the surface of the object 126 that is towards the light beam. At this moment, the image capturing device 104 captures the image of the speckle pattern shown on the surface of the object and produces object image information IMG3 sent to the processing module 106.

After receiving the object image information IMG3, the processing module 106 would compare the object image information IMG3 with one of the first reference image information IMG1 and the second reference image information IMG2. Therefore, the processing module 106 would obtain the displacement information of the speckle pattern on the object image information IMG. In continuous, the processing module can obtain the relative distance between the object 126 and the first flat surface 122 or the second flat surface 124 according to the displacement information of the speckle pattern on the object image information IMG3 and the displacement vector.

In the present embodiment, the step of obtaining the displacement vectors includes the operation of sum of absolute difference (SAD). The displacement of the speckle pattern depends on the surrounding images and SAD of each possible position, wherein the minimum SAD is considered to be the displacement vector. In addition, in some embodiments, the displacement vector can also be obtained by using the sum of absolute transformed difference (SATD). The so-called absolute transformation means transforming an absolute value by a transformation formula. In addition, the displacement vector can also be obtained by using the sum of squared difference (SSD), in other word, by subtracting the absolute value and calculating the sum of squares.

In some alternative embodiments, at least one of an adjusting formula and an adjusting value lookup table is established in the processing module. In these embodiments, when the processing module 106 obtains the object image information IMG, the processing module can calculate the absolute position of the object according to the displacement information of the speckle pattern on the object image information IMG, the displacement vector, at least one of the adjusting formula and the adjusting value lookup table.

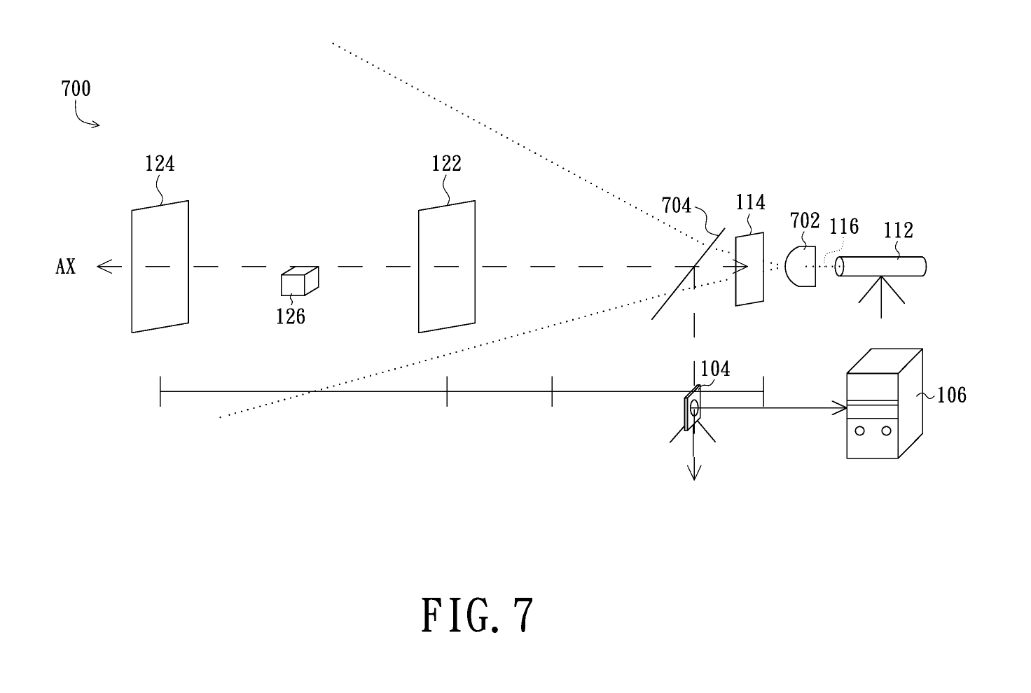

FIG. 7 is a schematic view illustrating a distance measuring system in accordance with the second embodiment of the present invention. Referring to FIG. 7, in the first embodiment, the image capturing device 104 is disposed at a side of the optical axis AX, and between the laser light source 112 and the first flat surface 122. However, in the distance measuring system 700 provided by the present embodiment, the center of the lens of the image capturing device 104 is aligned with the optical axis AX. Additionally, in the present embodiment, a lens 702 is disposed between the laser light source 112 and the light diffusing element 114 (i.e., the transmission path). When the laser beam 116 passes through the lens 702 it will be scattered and then reaches to the light diffusing element 114. A splitter 704 is disposed between the light diffusing element 114 and the first flat surface 122. Thus, a portion of the light reflected by the first flat surface 122, the second surface 124 and the object 16 would be transmitted by the splitter to the image capturing device 104. As such, the center of the lens of the image capturing device 104 can be aligned with the optical axis AX.

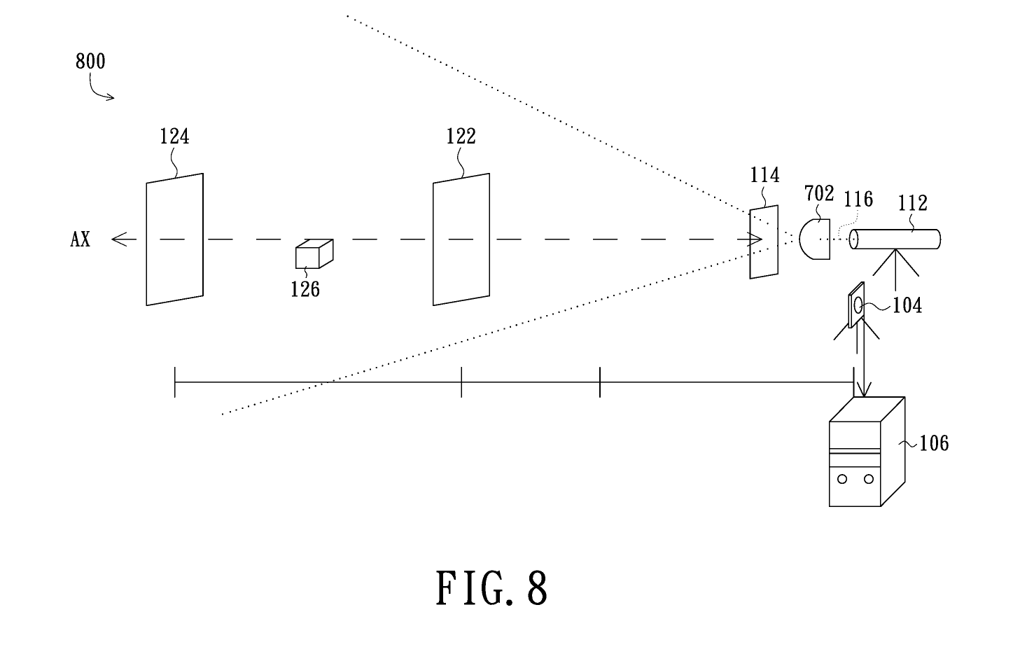

FIG. 8 is a schematic view illustrating a distance measuring system in accordance with the third embodiment of the present invention. Referring to FIG. 8, in the distance measuring system 800 provided by the present embodiment, the image capturing device 104 can be disposed at the position corresponding to the laser light source 112. Other devices, have been described in above paragraphs, and are not described here for brief.

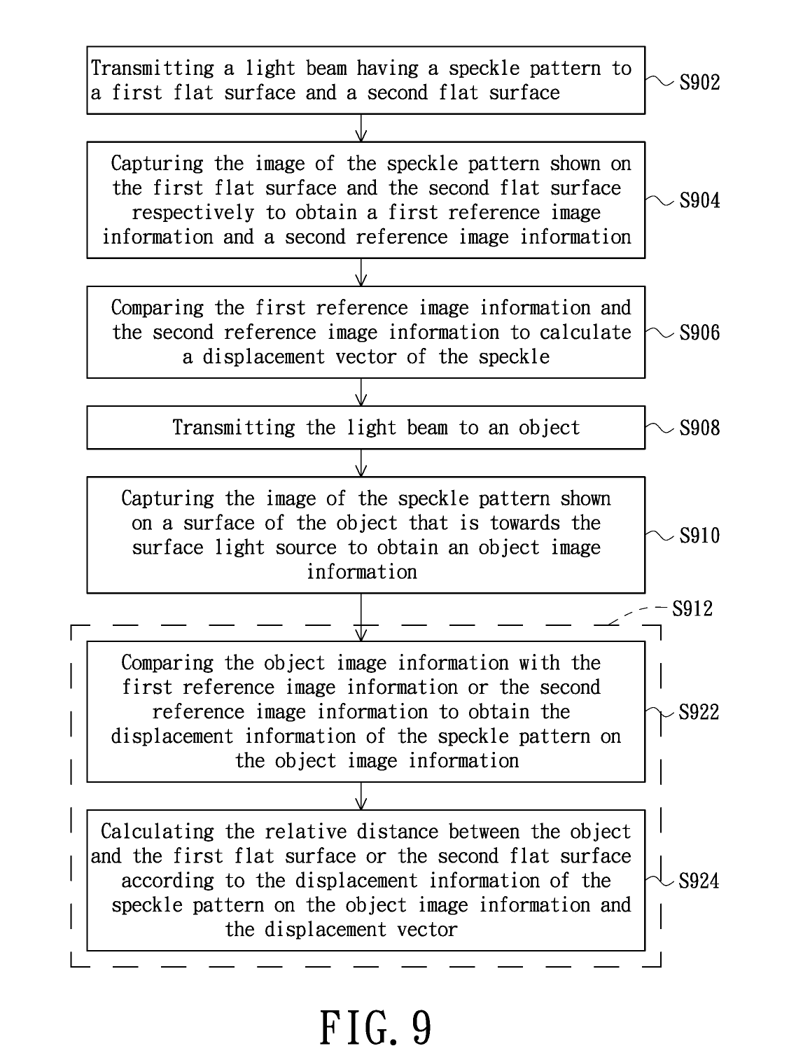

FIG. 9 is a flow chart illustrating steps of a distance measuring method in accordance with a preferred embodiment of the present invention. Referring to FIG. 9, the distance measuring method provided by the present embodiment is probably implemented by a processing software suitable for installing in a distance measuring system for analyzing the position of an object. In some embodiment, the processing software can save in a storage media, such as an internal HDD, a USB device, an optical storage media, etc. The steps performed of the measuring method, as described in step S902 first, transmits a light beam having a speckle pattern to a first flat surface and a second flat surface, wherein the speckle pattern has a plurality of speckles. Then, as described in step S904, the method includes capturing the image of the speckle pattern shown on the first flat surface and the second flat surface respectively to obtain first reference image information and second reference image information. At this moment, the present embodiment can compare the first reference image information and the second reference image information to calculate the displacement vector of the speckle pattern as the description in the step S906, in other words, the position variation of the speckle pattern on different flat surfaces.

Besides, as described in step S908, the light beam is transmitted to an object. Therefore, the present embodiment can capture the image of the speckle pattern shown on the surface of the object that is towards the light beam to obtain the object image information, as described in step S910. Then, the present embodiment can implement the step S912 that calculates the position of the object according the displacement vector of the speckle pattern and the position of the speckle pattern on the object image information.

In the present embodiment, the step S912 include the step S922, in other words, comparing the object image information with the first reference image information or the second reference image information to obtain the displacement information of the speckle pattern on the object image information. Then, the step S924 is performed, which includes calculating the relative distance between the object and the first flat surface or the second flat surface according to the displacement information of the speckle pattern on the object image information and the displacement vector.

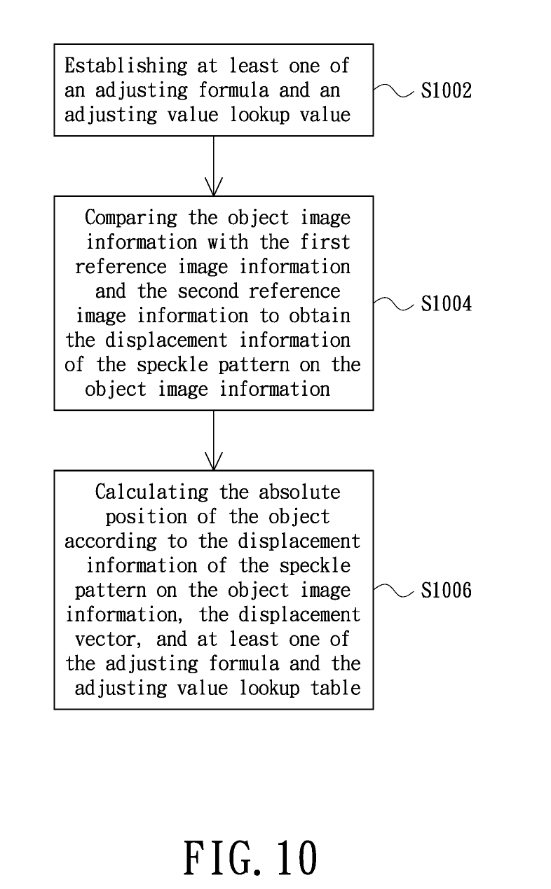

FIG. 10 is a flow chart illustrating the steps of calculating the position of the object according the displacement vector of each speckle in accordance with another embodiment of the present invention. Referring to FIG. 10, in the present embodiment, the step S912 in FIG. 9 includes firstly performing step S1002, that is establishing at least one of an adjusting formula and an adjusting value lookup table. Then, the step S1004 is performed, which includes comparing the object image information with the first reference image information or the second reference image information to obtain the displacement information of the speckle pattern on the object image information. After that, the step S1006 can be performed, which includes calculating the absolute position of the object according to the displacement information of the speckle pattern on the object image information, corresponding displacement vector and at least one of the adjusting formula and the adjusting value lookup table.

In summary, the present invention utilizes the displacement vector of each speckle to calculate the distance of the object. Thus, in the present invention, fewer surfaces (the first flat surface and the second flat surface) would be used and thus can efficiently simplify the processing procedure of the software.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A distance measuring system, comprising:
a light source module, configured for transmitting a light beam having a speckle pattern to a first flat surface and a second flat surface, so as to show the speckle pattern on the first flat surface and the second flat surface, wherein the speckle pattern has a plurality of speckles;
an image capturing device, configured for capturing a plurality of images of the speckle pattern shown on the first flat surface and the second flat surface to produce first reference image information and second reference image information, and of the speckle pattern shown on an object when the light beam is transmitted to the object, wherein the image capturing device captures the image of the speckle pattern shown on the surface of the object to produce object image information; and
a processing module, configured for obtaining the first reference image information and the second reference image information, and calculating a displacement vector of the speckle pattern shown on the first reference image information and the second reference image information, and the processing module comparing the object image information with one of the first reference image information and the second reference image information to obtain displacement information of the speckle pattern shown on the object image information, so as to calculate a relative distance between the object and the first flat surface or the second flat surface according to the displacement vector and the displacement information,
wherein displacement of the speckle pattern depends on a plurality of surrounding images and a sum of absolute difference (SAD) of each one of a plurality of possible positions, a minimum SAD is considered to be the displacement vector.

2. The distance measuring system of claim 1, wherein the light source module comprises a planar light source module.

3. The distance measuring system of claim 2, wherein the light source module comprises:
a laser light source, configured for emitting a laser beam; and
a light diffusing element, disposed on a transmission path of the light beam and configured for receiving the laser beam and causing the laser beam to perform diffraction and interference to form the light beam.

4. The distance measuring system of claim 3, wherein the light diffusing element is a diffusion sheet, a piece of ground glass or an optical diffraction element.

5. The distance measuring system of claim 1, wherein the image capturing device is a camera or a charge coupled device.

6. The distance measuring system of claim 1, wherein the first flat surface and the second flat surface are parallel to each other within a visual range, and substantially perpendicular to an optical axis of the light beam.

7. A distance measuring system, comprising:
a light source module, configured for transmitting a light beam having a speckle pattern to a first flat surface and a second flat surface, so as to show the speckle pattern on the first flat surface and the second flat surface, wherein the speckle pattern has a plurality of speckles;
an image capturing device, configured for capturing a plurality of images of the speckle pattern shown on the first flat surface and the second flat surface to produce first reference image information and second reference image information, and of the speckle pattern shown on an object when the light beam is transmitted to the object, wherein the image capturing device captures the image of the speckle pattern shown on the surface of the object to produce object image information; and
a processing module, configured for obtaining the first reference image information and the second reference image information, and calculating a displacement vector of the speckle pattern shown on the first reference image information and the second reference image information, and the processing module comparing the object image information with one of the first reference image information and the second reference image information to obtain displacement information of the speckle pattern shown on the object image information, so as to calculate a relative distance between the object and the first flat surface or the second flat surface according to the displacement vector and the displacement information,
wherein the displacement vector is obtained by using a sum of absolute transformed difference (SATD), an absolute transformation means transforming an absolute value by a transformation formula.

8. The distance measuring system of claim 7, wherein the light source module comprises a planar light source module.

9. The distance measuring system of claim 8, wherein the light source module comprises:
a laser light source, configured for emitting a laser beam; and
a light diffusing element, disposed on a transmission path of the light beam and configured for receiving the laser beam and causing the laser beam to perform diffraction and interference to form the light beam.

10. The distance measuring system of claim 9, wherein the light diffusing element is a diffusion sheet, a piece of ground glass or an optical diffraction element.

11. The distance measuring system of claim 7, wherein the image capturing device is a camera or a charge coupled device.

12. The distance measuring system of claim 7, wherein the first flat surface and the second flat surface are parallel to each other within a visual range, and substantially perpendicular to an optical axis of the light beam.

13. A distance measuring system, comprising:
a light source module, configured for transmitting a light beam having a speckle pattern to a first flat surface and a second flat surface, so as to show the speckle pattern on the first flat surface and the second flat surface, wherein the speckle pattern has a plurality of speckles;
an image capturing device, configured for capturing a plurality of images of the speckle pattern shown on the first flat surface and the second flat surface to produce first reference image information and second reference image information, and of the speckle pattern shown on an object when the light beam is transmitted to the object, wherein the image capturing device captures the image of the speckle pattern shown on the surface of the object to produce object image information; and
a processing module, configured for obtaining the first reference image information and the second reference image information, and calculating a displacement vector of the speckle pattern shown on the first reference image information and the second reference image information, and the processing module comparing the object image information with one of the first reference image information and the second reference image information to obtain displacement information of the speckle pattern shown on the object image information, so as to calculate a relative distance between the object and the first flat surface or the second flat surface according to the displacement vector and the displacement information,
wherein the displacement vector is obtained by using a sum of squared difference (SSD), the SSD is obtained by subtracting an absolute value and calculating the sum of squares.

14. The distance measuring system of claim 13, wherein the light source module comprises a planar light source module.

15. The distance measuring system of claim 14, wherein the light source module comprises:
a laser light source, configured for emitting a laser beam; and
a light diffusing element, disposed on a transmission path of the light beam and configured for receiving the laser beam and causing the laser beam to perform diffraction and interference to form the light beam.

16. The distance measuring system of claim 15, wherein the light diffusing element is a diffusion sheet, a piece of ground glass or an optical diffraction element.

17. The distance measuring system of claim 13, wherein the image capturing device is a camera or a charge coupled device.

18. The distance measuring system of claim 13, wherein the first flat surface and the second flat surface are parallel to each other within a visual range, and substantially perpendicular to an optical axis of the light beam.
